(19) United States
(12) Patent Application Publication
(10) Pub. No.: US 2017/0314739 A1
(43) Pub. Date: Nov. 2, 2017

(54) Gas Supply System and Method of Gas Supply

(71) Applicant: Linde Aktiengesellschaft, München (DE)

(72) Inventor: Bernd Rieker, Landsberg (DE)

(73) Assignee: Linde Aktiengesellschaft, Munchen (DE)

(21) Appl. No.: 15/522,890

(22) PCT Filed: Oct. 28, 2015
(86) PCT No.: PCT/EP2015/074981

§ 371 Date: Apr. 28, 2017

(30) Foreign Application Priority Data
Oct. 28, 2014 (EP) 14190586.9

(51) Int. Cl. F17C 13/04; F16K 17/38; F17C 13/02; F17C 7/00

(52) U.S. Cl. CPC F17C 13/04; F17C 7/00; F17C 13/025; F17C 13/026; F17C 13/028; F16K 17/38; F17C 2250/0473; F17C 2250/0443; F17C 2250/0439; F17C 2250/043; F17C 2250/0426; F17C 2250/03; F17C 2223/035; F17C 2221/011; F17C 2205/0394; F17C 2205/0385; F17C 2205/0338; F17C 2205/0326; F17C 2201/056; F17C 2201/0104; F17C 2250/0491; F17C 2250/0631; F17C 2250/072; F17C 2265/04; F17C 2270/0545; F17C 2270/025

(57) ABSTRACT

A valve arrangement (10) adapted to be coupled to, and to provide a gas flow from, a gas cylinder (20) containing a pressurized gas (21), the valve arrangement (10) comprising a blocking valve (1) with an obturator (11) movable by an actuator (12) from an opening position permitting a flow of the pressurized gas (21) through the blocking valve (1) into a closing position blocking the flow of the pressurized gas (21) through the blocking valve (1) is provided. Temperature sensing means (4) are provided which are adapted to provide at least one signal, the at least one signal being indicative of one or more temperatures of, in, and/or in vicinity to, the valve arrangement (10), and the actuator (12) is adapted to move the obturator (11) from the opening position into the closing position if the one or more temperatures indicated by the at least one signal are above a predetermined threshold value. A gas supply system (100) and a corresponding method of gas supply is also part of the invention.

### PRIOR ART

Advances in therapeutic uses of oxygen have resulted in its increased application for a number of clinical conditions, e.g. hypoxia and hypoxemia, respiratory depression, chronic obstructive pulmonary disease, pneumoconiosis, pneumonia, heart attack and pulmonary embolism, respiratory distress syndrome in new-borns, cluster headaches, respiratory burns and carbon monoxide poisoning. Classically, oxygen is used during surgery to maintain tissue oxygenation under anaesthesia, in resuscitation and for mechanical ventilation of the lung for the treatment of respiratory depression.

While oxygen for use in hospitals is often delivered in large quantities in liquid state by tank trucks and distributed to the points of use, e.g. wards or operation theatres, from a central distribution point via pipe systems and wall outlets, gas cylinders are used if smaller quantities are required, e.g. for homecare applications. In such applications, patients in need of long-term supplemental oxygen therapy or in need of intermittent but unpredictable oxygen demand often autonomously operate oxygen supply devices including gas cylinders without supervision of trained clinical staff.

While the present application mainly describes the use of oxygen in medical contexts, the invention is useful in any field in which oxygen is provided in a gas cylinder, e.g. for industrial applications such as welding or heating or for laboratory applications where oxygen is used in chemical reactions.

When using gas cylinders, the pressure of the compressed gas, e.g. 200 bar in larger and 50 bar in smaller cylinders, has to be reduced to a pressure suitable for the need of the user by means of a pressure regulator. Classically, valve arrangements including at least two separate valves were used to that purpose, including an on/off valve directly connected to the gas cylinder and a flow-regulation valve downstream thereof. In such classical valve arrangements, the pressure of the compressed gas in the gas cylinder and the pressure of the oxygen delivery line can be measured via separate manometers and the gas flow can be adapted accordingly.

As such valve arrangements are, however, rather bulky and their operation is often considered laborious or at least unintuitive, so-called valve integrated pressure regulators (VIPR) have become increasingly popular during the recent years. A VIPR device may also comprise the two valves mentioned above, i.e. an on/off valve directly connected to the gas cylinder and a flow regulation valve downstream thereof. These valves are, however, typically integrated together with further valves and/or other components into one compact design and may operable via a single device, e.g. a mechanical handle and/or electronic input means.

WO 2012/164240 A2 discloses a VIPR device comprising a control valve with an aperture for compressed gas and a variable aperture obturator. The aperture obturator is coupled for movement with and by an actuator. To monitor a position of the aperture obturator and, correspondingly, of the opening state of the control valve, a valve position monitor is provided. By monitoring the position of the aperture obturator and of a pressure of the compressed gas in the gas cylinder coupled with the VIPR, a remaining oxygen supply time can be estimated with high accuracy.

As analysed by E. T. Forsyth et. al. in “Oxygen Fire Hazards In Valve-Integrated Pressure Regulators For Medical Oxygen”, J. ASTM Int. 6(10), 2009, DOI 10.1520/JAI102296, VIPR devices may pose significant fire hazards that can differ greatly from those found in the stand-alone versions of the separate components, i.e. from classical valve arrangements as described above. While not combustible itself, oxygen can increase the flammability of other materials or gases and supports or accelerates combustion.

In case of a fire sustained by oxygen from a gas cylinder, it is obviously necessary to shut down additional oxygen supply as soon as possible. While this may be relatively easy in classical valve arrangements including separate valves, it may become increasingly difficult in VIPR devices where the place of ignition and the valve to be operated may be closely adjacent to each other and, e.g. due to increased temperature and/or due to panic, cutting the oxygen supply is no more possible or at least extremely difficult. Furthermore, additional fire-fighting measures besides cutting oxygen supply may become difficult due to the compact design, especially if a fire breaks out within a VIPR device not directly accessible from the outside.

US 2003/127413 A1 discloses a valve for preventing the flow of fluid when the temperature of the fluid is above a predetermined threshold, the valve including: a body having at least one opening for allowing the fluid to pass when the temperature of the fluid is below the predetermined threshold; and a shape memory or bi-metal actuator for substantially closing the at least one opening when the temperature of the fluid is above the predetermined threshold to prevent the fluid from passing.

In U.S. Pat. No. 5,522,428 A, a natural gas vehicle fuel system is disclosed which includes a composite pressure vessel for storing natural gas. The vessel includes an internal storage space accessible via a port opening. A solenoid valve is operatively coupled to the port opening for selectively connecting the storage space to a natural gas supply for filling or to a vehicle engine, in use. A sensor is integrally mounted with the vessel for sensing a select event of vessel operation indicative of the vessel exceeding a useful life expectancy. A control is operatively associated with the sensor for controlling the valve operation, the control preventing further operation of the solenoid valve after the vessel has exceeded the useful life expectancy.

WO2013/045043 A1 relates to a device for storing a gaseous fuel in a vehicle, comprising a pressure tank with a temperature sensitive component and a valve arrangement for limiting the gas flow into the pressure tank during filling. The valve arrangement interacts with the temperature sensitive component in such a way that when a temperature limit is reached, the gas flow into the pressure tank is reduced.

There is a need for valve arrangements, gas supply systems and corresponding methods with improved emergency operability.

### DISCLOSURE OF THE INVENTION

This object is solved by a gas supply system and a method of gas supply including the features of the independent claims. Preferred embodiments of the invention and further features are subject of the dependent claims and of the description that follows.

### ADVANTAGES OF THE INVENTION

Fire-protection devices for clinical oxygen supply devices are generally known from the prior art. According to WO 2006/021775 A1, an oxygen administration apparatus is provided, the apparatus including a source of oxygen, an oxygen administration device, a flexible oxygen conducting line connectable at one end to the source of the oxygen and at another end to an oxygen administration device and a safety valve in the line. The safety valve comprises a shuttle, a sealing member carried by the shuttle, means biasing the shuttle in a valve closing direction, and a fusible stop preventing closure of the valve. Fusing of the stop, caused, for example, by the heat generated by a fire, allows the biasing member to close the valve and hence shut off the supply of oxygen. A corresponding safety valve has, however, been found only of limited use in connection with VIPR devices, as a fire may still break out upstream of the safety valve. Furthermore, such a safety valve cannot be coupled directly to a gas cylinder, primarily due to the high pressure of the compressed gas therein.

VIPR devices for use with gas cylinders, like classical valve arrangements as mentioned above, typically comprise two valves, one of which is adapted to prevent or allow a flow of a pressurized gas from the gas cylinder. This valve is also referred to as an “on/off” valve or a “primary” valve. Downstream this valve, in VIPR devices, typically a second valve, also referred to as “flow-control valve”, is provided. The present invention is not limited to a specific one of these valves but may be used in connection with any valve allowing for an effective blockage of a gas flow from the gas cylinder. The valve is therefore referred to as a “blocking valve” and could also be referred to as an isolating valve according to EN 736-1:1995. Typically, the blocking valve can be the on/off valve directly connected to the gas cylinder mentioned above.

In case of a fire, as mentioned, the blocking valve should be turned off to prevent further pressurized, especially oxygen rich, gas to leave to gas cylinder and further sustain the fire. Typical blocking valves comprise an obturator movable by an actuator, which is, in classical valve arrangements and/or VIPR devices, realized as a manually operable actuator. The obturator is movable by the actuator from an opening position permitting a flow of the pressurized gas through the blocking valve into a closing position blocking the flow of the pressurized gas through the blocking valve. The blocking valve is blocked or closed by moving the obturator into the blocking or closing position, conventionally by turning a manually operable actuator.

The obturator, and consequently the specific movement of the obturator from the opening into the closing position, may be realized in any suitable way known from the prior art. Especially, the movement of the obturator may be a linear movement, e.g. as in different types of gate valves, globe valves, piston valves and diaphragm valves. While, in such valves, the movement of the obturator is a linear one, the actuator may be turned, e.g. for screw displacement of the obturator. However, linear displacement of the actuator together with the obturator may also be possible. The movement of the obturator may also be a rotating movement, e.g. as in different types of ball valves and butterfly valves. Also in such cases, while the movement of the obturator is a rotating one, the actuator may perform a linear displacement, e.g. to act upon a handle of such a valve. The actuator may, however, also rotate together with the obturator. As mentioned below, the actuator may also comprise a biasing element performing the actual movement of the obturator, while a further element may be provided to hold back the obturator against a biasing force of the biasing element.

In all cases, as mentioned above, due to a fire, the blocking may not be operable anymore due to the increased temperature, but also due to deformation and/or fusion of valve elements, especially plastic elements.

According to the present invention, therefore, a valve arrangement in a gas supply system adapted to be coupled to, and to provide a control gas flow from, a gas cylinder of the gas supply system containing a pressurized gas comprises temperature sensing means adapted to provide at least one signal, the at least one signal being indicative of one or more temperatures of, in, and/or in vicinity to, the valve arrangement. The actuator, according to the present invention, is adapted to move the obturator from the opening position into the closing position if the one or more temperatures indicated by the at least one signal are above a predetermined threshold value.

According to the present invention, the valve arrangement further comprises a flow regulating valve arranged downstream the blocking valve and at least the blocking valve and the flow-regulating valve are arranged in a common housing of a valve integrated pressure regulator (VIPR).

By means of the current invention, a corresponding valve arrangement can be reliable brought into a secure state in case of a fire, even if the blocking valve is, e.g. due to elevated temperature, no more operable by hand. Furthermore, the present invention allows for an early intervention in case of a fire in or in vicinity to the valve arrangement, even before an operator may notice such a fire, and thus prevents further damage. Especially, the blocking valve may be closed before it is damaged, e.g. deformed, to an extent in which is not operable anymore.

According to the present invention, the temperature sensing means may comprise one, two or more sensors, which may be arranged at one or more different positions in, on or in vicinity of the valve arrangement, and an optional evaluation device. The sensors may also be embodied as so-called intelligent sensors which do not simply supply a sensor value in form of an analogue or digital signal, but already communicate a temperature derived from such a signal. Under a “signal”, however, any value being indicative of one or more temperatures is to be understood. This signal may or may not be processed in the at least one sensor, the evaluation device, a central processing unit, the actuator itself and/or in further units. The actuator may be adapted to move the obturator from the opening position into the closing position if the one or more temperatures indicated by the at least one signal is above a predetermined threshold value by being equipped with a processing unit that processes the signal provided by the temperature sensing means and/or a further unit, but may also be correspondingly adapted by simply being responsive to a closing signal generated from a further unit, as mentioned above, on the basis of the signal provided by the sensing means.

For example, the present invention may involve the use of two sensors, one of which being arranged within the valve arrangement, i.e. within a housing enclosing the blocking valve, and another sensor being arranged on the outside of the valve arrangement. In such an arrangement, two or more temperature sensors may also provide a temperature gradient or a temperature ratio. For example, if a temperature within the valve arrangement exceeds the temperature outside the valve arrangement, this may be the result of a present and/or imminent fire within the valve arrangement and vice versa. Two ore more sensors and/or corresponding signals may also be correlated and/or mutually validated, according to a preferred embodiment of the present invention. For correlation and/or validation of signals, also a signal indicative of the surrounding temperature may be used.

By setting the threshold value to a sufficiently low temperature, which has, however, a sufficient temperature distance from the surrounding temperature, a fire may be detected early enough to provide an adequate reaction, especially when the elements of the valve arrangement are not yet damaged.

Further security features may be additionally provided, according to preferred embodiments of the invention. For example, an especially preferred embodiment of the invention may include that the actuator is further adapted to move the obturator from the opening position into the closing position if the sensor signal is indicative of a malfunction and/or a power failure of the temperature sensing means.

For example, the temperature sensing means may be adapted, as mentioned, to correlate and/or mutually validate sensor signals. If, in this way, a signal is identified as faulty, the temperature sensing means may output a signal indicating that the temperature sensing means could be malfunctioning. For example, under such conditions, a high (“1”) or low (“0”) value, a specific digital value (e.g. “0000” or “9999”) or a characteristic pulse train may be output. However, under such conditions, the signal may also intentionally be set to a value corresponding to a temperature above the threshold value, e.g. the maximum value of a corresponding sensor. In response to such a signal, the actuator may then, as a safety measure, close the blocking valve, i.e. move the obturator of the blocking valve from the opening position into the closing position. Such a safety measure may also include that the obturator closes the blocking valve if the signal indicates that the temperature sensing means have a power failure. In this case, the sensor signal may cease to be sent and/or e.g. have a value of 0 V. As, in such situations, the malfunction and/or the power failure of the temperature sensing means may also result from a fire, the safe reaction of the actuator is to move the obturator into the closing position, i.e. to block the flow of the pressurized gas.

According to an especially preferred embodiment of the present invention, the actuator may be adapted to move the obturator towards the closing position by exerting a moving force upon the obturator. This means that, according to this preferred embodiment of the invention, the actuator is the element that actually moves the obturator. In such cases the actuator may e.g. comprise a linear and/or rotary electric motor and/or a pneumatic cylinder.

However, especially in view of enhanced security, the actuator may also be adapted, according to a further preferred embodiment of the invention, to move to obturator towards the closing position by reducing a holding force exerted upon the obturator. This embodiment has the specific advantage that the actuator must not necessarily move the obturator itself. For example, the obturator may be, in such cases, coupled to a biasing element, e.g. a spring, exerting a force towards the closing position upon the obturator. In the opening position, a holding force acts against a biasing force of the biasing element, e.g. the spring, and holds the obturator in the opening position. An advantage of this preferred embodiment is that, if the actuator is subject to a power failure causing the holding force to decrease, the blocking valve is, by default, brought into the closing position, even without any power supply. In consequence, the blocking valve is closed both by the sensor signal indicative of a high temperature which may be due to a fire, by a malfunction and/or a power failure of the temperature sensing means, and also by a power failure of the actuator.

Besides an electric motor as mentioned above, the actuator according to a especially preferred embodiment may comprise further electro-mechanic elements, for example an electric magnet. Such an electric magnet may be used in the preferred embodiment as explained above, i.e. in the preferred embodiment wherein the actuator is adapted to move to obturator towards the closing position by reducing a holding force exerted upon the obturator. The holding force, when using an electric magnet, is exerted upon the obturator by the electric magnet. If a power supply to the electric magnet fails, the biasing force may move the obturator into the closing position.

According to a further preferred embodiment of the invention, the actuator may comprise a pneumatically operable element, e.g. a pneumatic cylinder. The specific advantage of this embodiment of the present invention is that such a pneumatic element may be operated with the pressurized gas contained in the gas cylinder. This means that no further sources of pressurized gas, e.g. an external pump, and/or no electro-mechanic elements like linear or rotary electric motors and/or electric magnets requiring further electric power have to be provided.

According to a preferred embodiment of the present invention, the blocking valve comprises a refractory material. Under a refractory material, a material resistant, at least to some extend, to fire, is to be understood herein. This ensures that the blocking valve is still operable even in case of fire.

As mentioned above, especially in a VIPR device, valve arrangements typically include a further valve, termed flow-regulating valve, which is arranged downstream the primary valve, e.g. the blocking valve mentioned above, in the flow path from the gas cylinder. According to the present invention, wherein the valve arrangement is embodied as and/or as a part of a VIPR device, the flow-regulating valve and the blocking valve are arranged in a common housing.

In an especially preferred embodiment of the present invention, the valve arrangement further comprises indication means adapted to indicate a pressure, a flow rate, a remaining gas volume, a remaining usage time and/or a temperature of the pressurized gas in the gas cylinder. For further details of such devices, specific reference is made to WO 2012/164240 A2 mentioned above. Especially, the valve arrangement according to the present invention may be embodied as a VIPR, especially as a electrically powered VIPR, e.g. comprising a power supply. In such a VIPR, power to supply the temperature sensing means is already provided.

The present invention also relates to a corresponding method of gas supply. For features and specific advantages of the inventive method, reference is made to the explanations above.

As mentioned, the present application is useful fuse of oxygen in medical contexts, the invention is useful in any field in which oxygen is provided in a gas cylinder, e.g. for industrial applications such as welding or heating or for laboratory applications where oxygen is used in chemical reactions.

The invention is further explained with reference to the appended drawings which show preferred embodiments of the invention.

### SHORT DESCRIPTION OF THE FIGURES

FIG. 1 schematically illustrates a gas supply system according to a preferred embodiment of the invention.

FIG. 2 schematically illustrates details of a valve arrangement according to a preferred embodiment of the invention.

In the figures, like elements are indicated with identical reference numerals. A repeated explanation is omitted for reasons of conciseness.

### EMBODIMENTS OF THE INVENTION

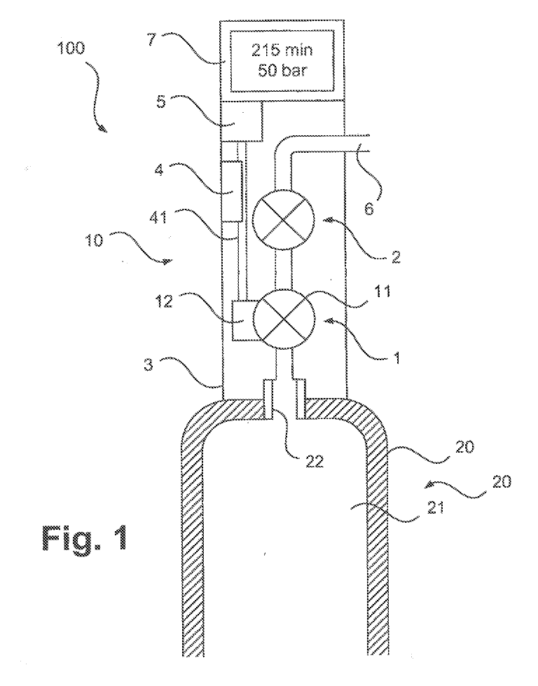

FIG. 1 schematically illustrates a gas supply system 100 according to a preferred embodiment of the invention. The gas supply system 100 comprises a valve arrangement 10 and a gas cylinder 20, the gas cylinder 20 containing a pressurized gas 21, especially oxygen, at a pressure of e.g. 50 or 200 bar.

The valve arrangement 10 comprises, in the exemplary embodiment shown, a blocking valve 1 and a flow-regulating valve 2. The blocking valve 1 and the flow-regulating valve 2 may be enclosed in a housing 3. The blocking valve 1 and the flow-regulating valve 2 may be embodied with obturators known from a prior art and may e.g. be realised as gate valves, globe valves, piston valves, diaphragm valves, ball valves and butterfly valves. In the following, the function of the blocking valve 1 is explained in more detail while for the function of the flow-regulating valve 2, reference is made to e.g. WO 2012/164240 A2. For reasons of generality, an obturator of the blocking valve 1 is shown in simplified form and referred to with 11. The valve arrangement 10 may be coupled to the gas cylinder 20 by suitable coupling means 22, e.g. via a screw or bayonet connection including suitable gaskets.

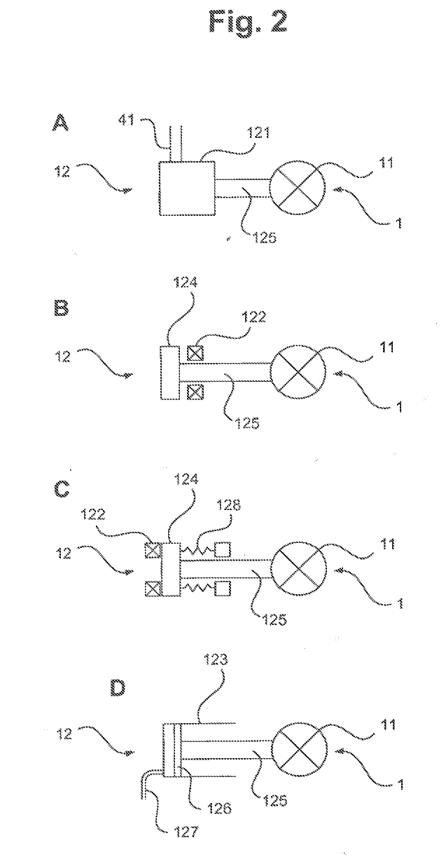

In the preferred embodiment illustrated in FIG. 1, the blocking valve 1 of the valve arrangement 10 comprises an actuator 12, as explained above, adapted to act upon the obturator 11 of the valve 1. Details of actuators 12 suitable for use in the present invention are also explained with regard to FIG. 2.

The valve arrangement 10 of the gas supply system 100 furthermore comprises temperature sensing means 4 adapted to provide at least one signal at least indicative of on or more temperatures of, in and/or in vicinity to the valve arrangement 10. The temperature sensing means 4 may, to that purpose, be equipped with one or more sensors, as already explained above. Individual sensors of the temperature sensing means 4 are omitted for clarity. According to the embodiment of the present invention illustrated in FIG. 1, the temperature sensing means 4 may be coupled to the actuator 12 via suitable couplings, e.g. via a lead 21.

The sensing means 4 and the actuator 2, if an electronically or electrically operated actuator 12 is provided, may be coupled to a common energy source 5, e.g. a battery, via suitable leads illustrated as dotted lines.

The valve arrangement 10 is adapted to provide a regulated gas flow of the pressurized gas 21 contained in the gas cylinder 20 via a lead 6. The lead 6 may e.g. be coupled with a patient oxygen supply device, e.g. a nasal cannula (not shown) or with an industrial gas consumer.

According to an embodiment of the present invention, the valve arrangement 10 and/or the gas supply system 100 may also comprise indicating means 7 adapted to indicate e.g. a pressure, a flow rate, a remaining gas volume, a remaining gas usage time and/or a temperature of the pressurized gas in the gas cylinder 20. To that purpose, that indication means 7 may comprise and/or may be coupled with control and/or measuring means which are not displayed in FIG. 1. Also the indication means 7 may be coupled to the energy source 5.

In FIG. 2, different embodiments of actuators 12 of the blocking valves 1 are schematically illustrated and referred to with reference letters A to D. The actuators 12 are shown in part and in highly simplified form.

According to a first embodiment, referred to with A, the obturator 11 of the blocking valve may be coupled with an actuator 12 comprising an electric motor 121. The electric motor may 121 comprise a motor control unit (not shown) which is operated on the basis of a signal provided via the signal line 41.

The electric motor 121 may for example rotate a rotating obturator 11 of the blocking valve 1 and/or displace a linear moving obturator 11 correspondingly, if the motor 121 is embodied as a linear motor. A shaft 125 may be rotated around its longitudinal axis and/or displaced parallel to its longitudinal axis by the motor 121.

According to the embodiment referred to with B, the actuator 12 may comprise an electric magnet 122 which may be activated dependent of the signal of the temperature sensing means 4. In the specific example displayed in FIG. 2 according to B, the electric magnet 122 may attract an anchor 124 coupled to the shaft 125 and thus cause e.g. a linear displacement of the obturator 11 of the blocking valve 1.

According to a modification referred to with C, an anchor 124 of the actuator 12 is spring-biased towards a closing position of the obturator 11 by pull springs 128 and held in an open position via an electric magnet 122. If the electric magnet releases the anchor 124 due to a specific signal and/or a power failure of the electric magnet 122, the anchor 124, together with the shaft 125 is moved to a closing position of the obturator 11 by the pull springs 128. Obviously, instead of pull springs 128, and including an inverse arrangement as immediately evident to the skilled person, also push springs may be used in this context.

According to a further embodiment, referred to with D, an actuator 12 may comprise a pneumatic element which is, in the example shown, embodied as a pneumatic cylinder 123. A piston 126 arranged in the pneumatic cylinder 123 may be displaced by a pressurized gas introduced into the pneumatic cylinder 123 via a gas inlet 127. The gas inlet 127 may especially be coupled with the gas cylinder 20 and/or supplied with gas 21 under pressure provided in the gas cylinder 21.

Further embodiments are possible as well, e.g. a pneumatic element 123 and/or an electric motor 121 may also be coupled with biasing springs 128.

1. A gas supply system (100) comprising a gas cylinder (20) containing a pressurized gas (21) and a valve arrangement (10) coupled to, and adapted to provide a gas flow from, the gas cylinder (20), the valve arrangement (10) comprising a blocking valve (1) with an obturator (11) movable by an actuator (12) from an opening position permitting a flow of the pressurized gas (21) through the blocking valve (1) into a closing position blocking the flow of the pressurized gas (21) through the blocking valve (1), the valve arrangement (10) further comprising temperature sensing means (4) adapted to provide at least one signal, the at least one signal being indicative of one or more temperatures of, in, and/or in vicinity to, the valve arrangement (10), and by the actuator (12) being adapted to move the obturator (11) from the opening position into the closing position if the one or more temperatures indicated by the at least one signal are above a predetermined threshold value, characterized in that the valve arrangement (10) further comprises a flow-regulating valve (4) arranged downstream the blocking valve (1), and in that at least the blocking valve (1) and the flow-regulating valve (4) is arranged in a common housing of a valve integrated pressure regulator.

2. A system (100) according to claim 1, wherein the actuator (12) is adapted to move the obturator (11) towards the closing position by exerting a moving force upon the obturator (11).

3. A system (100) according to claim 1, wherein the actuator (12) is adapted to move the obturator (11) towards the closing position by reducing a holding force exerted upon the obturator (11).

4. A system (100) according to claim 3, wherein the obturator (11) is biased towards the closing position by a biasing force and held in the opening position by the holding force acting against the biasing force.

5. A system (100) according to any one of claims 2 to 4, wherein the actuator (12) comprises an electro-mechanic element (121, 122).

6. A system (100) according to claim 5, wherein the actuator (12) is adapted to move the obturator (11) towards the closing position upon a power failure of the electro-mechanic element (121, 122).

7. A system (100) according to any one of claims 2 to 4, wherein the actuator comprises a pneumatically operable element (123).

8. A system (100) according to any one of the preceding claims, wherein the blocking valve (1) comprises a refractory material.

9. A system (100) according to any one of the preceding claims, comprising indication means (7) adapted to indicate a pressure, a flow rate, a remaining gas volume, a remaining usage time, and/or a temperature of the pressurized gas (21) in the gas cylinder (20).

10. A method of gas supply from a gas cylinder (20) containing a pressurized gas (21), characterized in that a gas supply system (100) according to claim any one of claims 1 to 9 is used.
